(19) United States
(12) Patent Application Publication
(10) Pub. No.: US 2006/0007209 A1
(43) Pub. Date: Jan. 12, 2006

(54) Drive apparatus of liquid crystal panel and liquid crystal display apparatus

(75) Inventors: Tetsuya Nakamura, Osaka (JP); Seiji Kawaguchi, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/106,525

(22) Filed: Apr. 15, 2005

(30) Foreign Application Priority Data
Apr. 15, 2004 (JP) 2004-120820

(51) Int. Cl. G09G 5/00

(52) U.S. Cl. 345/204

(57) ABSTRACT

[Object]To provide a liquid-crystal display using liquid crystal having splay alignment and bend alignment, which prevents irregularity of a display screen after power off and quickly transfers the liquid-crystal layer of a liquid-crystal panel to bend alignment. [Solving Means]

A liquid-crystal panel drive 100 including an output system 102 of selectively outputting one voltage from a video signal voltage Vcom, a reset voltage Vsc, and transfer voltage of transferring the liquid-crystal panel from splay alignment to bend alignment, and control means 103, wherein the reset voltage is applied before applying the video signal voltage Vcom in the power-on state and thereafter the transfer voltage is applied, the transfer voltage is applied to the liquid-crystal panel in the power-off state, and then the reset voltage is applied and thereafter supply of a voltage to the liquid-crystal panel is stopped.

### FIELD OF THE INVENTION

The present invention relates to a liquid-crystal display device using an OCB mode and driving device thereof.

### BACKGROUND ART

The liquid-crystal display device is thin and lightweight, whose application has been further expanded in recent years as a substitute for a conventional cathode ray tube.

FIG. 7 now shows a general view of a liquid-crystal display device. In the liquid-crystal display device 400, a liquid-crystal panel 410 is constituted of a plurality of pixels 411 arranged like a matrix form and including a TFT 411a, a pixel electrode 411b connected through the TFT 411a, a liquid-crystal layer 411d held between the pixel electrode 411b and a counter electrode 411c, and a storage capacitor Cs connected to a common electrode 411e and the pixel electrode 411b. The source electrode of each TFT 411a in the liquid-crystal panel 410 is connected to a source driver 420 through a source line 412 and the gate electrode of each TFT 411a is connected to a gate driver 430 through a gate line 413.

The TFT 411a is opened or closed by a gate voltage Vg applied from the gate driver 430 and a video signal Vs is supplied from the source driver 420 to the pixel electrode 411b. Moreover, a voltage Vcom is applied to the counter electrode 411c and the common electrode 411e. Thereby, a predetermined gray scale voltage corresponding to the video signal Vs is held by a liquid-crystal capacity C_{LC} and a storage capacitor Cs constituting each pixel 411. Moreover, an image is displayed by receiving light-source light from a backlight 450 set to the back of the liquid-crystal panel 410.

In FIG. 7, source/gate control means 440 is means of receiving power from an external power supply and inputs of image signals to be displayed and driving the source driver 420 and gate driver 430 based on these signals. Moreover, the backlight 450 also turns on and off correspondingly to operations of the source/gate driving means 440.

A TN(Twisted Nematic)-mode liquid-crystal panel widely used for the liquid-crystal layer 411d of the liquid-crystal panel 410 is inferior in image quality to a self-light-emitting display such as a cathode ray tube because the panel has a narrow angle of visibility and a slow response speed and a holding-type liquid-crystal element causes trails to be seen in a dynamic image.

However, an OCB (Optically Compensated Bend)-mode liquid crystal using a bend alignment state has been proposed in recent years (for example, refer to Patent Document 1).

The OCB-mode liquid crystal can sufficiently accommodate dynamic image display and large screen because it has a high response speed and a wide viewing angle compared with the TN-mode liquid crystal, and has an advantage that it can provide a large-screen display which is thinner in size and lower in power consumption than that of a cathode ray tube.

However, the OCB-mode liquid crystal has two alignment states such as a splay alignment state and a bend alignment state. The splay alignment state is an initial-state of liquid-crystal alignment in which no voltage is applied to the OCB-mode liquid crystal as shown in FIG. 8(a) and the bend alignment state is an alignment state whose phase is transited by applying a voltage higher than a predetermined transfer voltage to the liquid crystal in the splay alignment state, and the bend alignment state is used to display images.

Moreover, as shown in FIG. 8(b), phase transition or reverse transition occurs in the bend alignment state and the splay alignment state depending on whether to regularly apply a voltage equal to or higher than a predetermined transfer voltage.

[Patent Document 1] Japanese Patent Laid-Open No. 61-116329

### DISCLOSURE OF THE INVENTION

[Problems to Be Solved by the Invention]

In the case of a liquid-crystal display device using OCB-mode liquid crystal, it takes a lot of time for the entire liquid-crystal layer surface to migrate to a uniform splay alignment state after turning off the power supply of a liquid-crystal display panel.

FIG. 9 is a time chart showing the operation of a liquid-crystal display using conventional OCB-mode liquid crystal when the power supply of the liquid-crystal display is turned off (hereafter referred to as power-off sequence). According to the power-off sequence shown in FIG. 9, the backlight 450 is turned off and at the same time, a voltage to be applied to the liquid-crystal layer 411d is turned off at the timing of turning off a liquid-crystal driving power supply.

According to this power-off sequence, because a voltage held by the liquid-crystal layer 411d constituting each pixel 411 varies depending on a display state displayed just before turning off a power supply, a portion to be quickly transited to the splay alignment and a portion to be slowly transited to the splay alignment occur when a display screen is transited to the splay alignment state after turning off the power supply. For example, at room temperature, approximately 5 sec is required to transit every liquid-crystal layer 411d to the splay alignment. More specifically, reverse transition from the bend alignment state to the splay alignment progresses in the following steps. First, when the voltage applied to OCB-mode liquid crystal becomes 0 V, the bend alignment becomes unstable and 180° twist occurs in all regions. In this case, 180° twist is liquid-crystal alignment in which the arrangement direction of liquid-crystal molecules is twisted between upper substrate and lower substrate and the twist angle is 180°. This alignment state is recognized as transparent, bright yellow. This twist alignment state may be referred to as second spry alignment.

However, in a state in which no voltage is applied to OCB-mode liquid crystal, the splay alignment is more stable than twist alignment. Therefore, there grows a splay alignment region remaining on a display surface or a splay alignment region accidentally generated by using foreign matter or protruded portion on the display surface as a core and finally, the entire display surface turned into the splay alignment and is stabilized. This splay alignment is, for example, transparent blue.

A problem is that it takes a lot of time for the entire surface of a liquid-crystal layer to transit to the splay alignment and a state in which twist alignment (yellow) and splay alignment (blue) are mixed after turning off the power supply is present for a predetermined time ununiformly or depending on the pattern at the time of display and thereby, when outside light is strong, difference between alignment states of various portions of the liquid-crystal layer 411d are seen on a screen as irregularity or afterimage.

Moreover, in the time until the present state is completely transited to the splay alignment after turning off the power supply, when turning on the power supply again, a long transfer driving period is necessary compared to a case of turning on the power supply from a uniform splay alignment state and a lot of time is required from the time when the power supply is turned on until the time when a video is displayed.

For the above inconvenience, an afterimage prevention circuit when turning off the power supply of a liquid-crystal display using conventional OCB-mode liquid crystal shown in FIG. 10 has been known so far.

As shown in FIG. 10, the afterimage prevention circuit 600 has a source driver 601 connected to source lines of outputting outputs of Y₁ to Y₃₈₄ and an input system having three open/close switches 602a to 602c of inputting reference voltages for the total of 10 systems from VREF0 to VREF9 to the source driver 601 and selecting these reference voltages. The open/close switches are constituted of an open/close switch 602a of supplying a voltage AVDD/2, an open/close switch 602b of supplying a voltage two times higher than the voltage AVDD/2, and an open/close switch 602c of controlling the connection with ground, and opening and closing of them are controlled by control voltages Vc4 and Vc5.

As shown by the timing chart in FIG. 11, the afterimage prevention circuit having the above configuration is set so that irregularity and afterimage are not seen by holding a period of white display of white-displaying the whole liquid-crystal panel in the period from normal display until power off. More specifically, the constant voltage AVDD/2 is supplied to VREF0 to VREF9 supplied to the source driver 601 as different fixed voltages at the time of normal display because the control voltage Vc4 is turned off and the control voltage Vc5 is turned on and thereby, the control switches 602b and 602c are turned off and the control switch 602a is turned on and the constant voltage AVDD/2 is output to outputs of Y1 to Y384 of the source driver 601 to perform white display. When the white display period is completed, supply of voltages is stopped by turning off the power supply.

FIG. 12 is a time chart showing operations of a liquid-crystal display using OCB-mode liquid crystal when a power supply is turned on. When the power supply of the liquid-crystal display is turned on at the time of t0, a factor that splay alignment is disordered is added to a liquid-crystal layer due to wraparound from various routes of a circuit. To correct the disorder of the splay alignment, 0 V is applied to a liquid-crystal layer in the period between the time t0 and the time t1. Then, after the liquid-crystal layer becomes a uniform splay alignment, a transfer voltage is applied in order to phase-transition the liquid crystal of the liquid-crystal layer 411d to a bend alignment from the time t1 to the time t2. After the transfer driving is completed at the time t2, a voltage corresponding to a video signal is applied to the liquid-crystal layer and an image is displayed.

In this case, when the power supply is turned on again in the period until the transition to the splay alignment is completed after the power supply is turned off as described above, disorder of second splay alignment is added in addition to the disorder of the splay alignment when the power supply is turned on as described above. Therefore, a lot of time is required for the time from t0 to t1. For example, the time from t0 to t1 is approximately 0.2 sec when turning on the power supply from a state not the second splay alignment. However, the time from t0 to t1 requires approximately 0.4 sec when the second splay alignment is present and the power supply is turned on. Thus, when the second splay alignment is present, it is necessary to previously set the time until an image is displayed after the power supply is turned on to a large value or a display trouble appears.

For the above trouble, the transfer circuit shown in FIG. 13 has been known so far.

As shown in FIG. 13, a transfer circuit 900 is built in the source/gate control means 440 and provided with an output terminal 910 of outputting data to the source driver 420 of the liquid-crystal display panel and an input system 920 having three selection switches capable of selectively supplying four types of voltages to the output terminal 910. Each selection switch is constituted of a selection switch 920a of selectively inputting a voltage V+ or V−, a selection switch 920b of selectively inputting a voltage Vsc or Vcom, and a selection switch 920c of selectively inputting outputs from the selection switches 920a and 920b, and opening and closing of them are controlled by control voltages Vc1, Vc2, and Vc3. In this case, each voltage is set on the basis of the voltage Vcom in a range of potential applied to a counter electrode in displaying images so that V− has a potential lower than Vcom, Vsc has a potential higher than Vcom, and V+ has a potential higher than Vsc.

The transfer circuit having the above configuration holds a transfer state of eliminating splay alignment by a drastic potential difference in the period from power on to normal display state as shown by the timing chart in FIG. 14.

More specifically, immediately after power on, each pixel electrode is reset while applying the voltage Vsc from the source driver, the selection switches 920a and 920b are set to LOW state and the selection switch 920c is set to HIGH state so that the voltage Vsc is supplied to a counter electrode, then in the transfer period, the selection switch 920c is set to LOW state while keeping the selection switches 920a and 920b as they are so that the voltage V+ is applied, and the selection switch 920a is set to HIGH state and then the voltage is collapsed from V+ to V−. In this case, a large potential of |V₊−Vsc| or |V₋−Vsc| in absolute value is applied to the liquid-crystal layer of the liquid-crystal panel as a transfer voltage to transit the liquid-crystal layer of the liquid-crystal panel from a splay alignment to a bend alignment.

When the transfer period is completed, the selection switches 920b and 920c are set to HIGH, that is, all the selection switches are set to HIGH state and the voltage Vcom is applied to transfer to normal display.

Thus, there are proposed techniques which eliminate respective display troubles when the power supply of the liquid-crystal display is turned off or on.

However, it is necessary to independently constitute respective circuits having the above actions for power on and power off and increase of a liquid-crystal display in size is brought about.

The present invention is made to solve the above problems and its object is to provide a drive apparatus of liquid-crystal panel and the like of a liquid-crystal display using OCB-mode liquid crystal and capable of preventing irregularity of a display screen after a power supply is turned on and quickly transferring the liquid-crystal layer of a liquid-crystal panel to bend alignment when the power supply is turned on.

### MEANS TO SOLVE THE PROBLEMS

The 1^{st} aspect of the present invention is a driving device for applying a voltage to a liquid-crystal panel having a liquid-crystal layer capable of being a splay alignment state or a bent alignment state, comprising:
a voltage output means of outputting at least one voltage selected from voltages including a video signal voltage, a reset voltage, and a transfer voltage for transiting the liquid-crystal panel from the splay alignment to the bend alignment, in accordance with power-off or power-on state of the liquid-crystal display panel, wherein
the voltage output means applies the reset voltage and then transfer voltage to the liquid-crystal display panel in this order before applying the video signal voltage at the power-on state, and applies the transfer voltage and then the reset voltage in this order before stopping to apply voltages at the power-off state.

The 2^{nd} aspect of the present invention is a driving device for applying a voltage to a liquid-crystal panel having a liquid-crystal layer capable of being a splay alignment state or a bent alignment state, comprising:
a voltage output means of selectively outputting one voltage from a plurality of voltages including at least a video signal voltage, a reset voltage, and a transfer voltage for transiting the liquid-crystal panel from the splay alignment state to the bend alignment; wherein
a first period of selecting the reset voltage and a second period of selecting the transfer voltage after the first period are successively set based on a non-signal of the liquid-crystal panel input from the outside, and
a third period of selecting the transfer voltage and a fourth period of selecting the reset voltage after the third period are successively set based on an off-signal of the liquid-crystal panel input from the outside.

The 3^{rd} aspect of the present invention is a driving device for applying a voltage to a liquid-crystal panel having a liquid-crystal capable of being a splay alignment or a bent alignment comprising:
a first driving circuit connected to one-hand electrode of the liquid-crystal panel to selectively apply a transfer voltage of transiting the liquid-crystal panel from the splay alignment to the bend alignment, a video signal voltage, and a reset voltage;
a second driving circuit connected to the other-hand electrode of the liquid-crystal panel to selectively apply a constant potential; and
a control circuit of controlling operations of the first driving circuit and the second driving circuit depending on a power-off signal or power-on signal of the liquid-crystal panel input from the outside; wherein
the control circuit controls the first driving circuit so as to set a first period for selecting the reset voltage, second period for selecting the transfer voltage, and third period for selecting the video signal voltage in this order based on the on-signal, and so as to set a fourth period for selecting the transfer voltage and fifth period for selecting the reset voltage in this order.

The 4^{th} aspect of the present invention is the liquid-crystal panel driving device according to any one of the 1^{st} or the 3^{rd} aspect of the present invention, wherein
the reset voltage has an absolute value smaller than that of the transfer voltage.

The 5^{th} aspect of the present invention is the liquid-crystal panel driving device according to the 1^{st} aspect of the present invention, wherein
the voltage output means applies a predetermined video signal voltage to become substantially uniform to each pixel of the liquid-crystal panel between application of the transfer voltage and application of the reset voltage in the power-off state.

The 6^{th} aspect of the present invention is the liquid-crystal panel driving device according to the 3^{rd} aspect of the present invention, wherein
the control circuit performs the control so as to insert a sixth period for applying a predetermined video signal voltage to become substantially uniform to each pixel of the liquid-crystal panel between the fourth period and the fifth period in the power-off state.

The 7^{th} aspect of the present invention is the liquid-crystal pane driving device according to the 5^{th} or the 6^{rd} aspect of the present invention, wherein
the substantially-uniform predetermined video signal voltage is for displaying Black display on the liquid-crystal panel.

The 8^{th} aspect of the present invention is the liquid-crystal panel driving device according to the 7^{th} aspect of the present invention, wherein
the reset voltage applied in the power-off state of the liquid-crystal panel is a video signal voltage is for displaying White display on the liquid-crystal panel.

The 9^{th} aspect of the present invention is the liquid-crystal panel driving device according to the 7^{th} aspect of the present invention, wherein
the reset voltage selected in the fifth period is a video signal voltage is for displaying Black display on the liquid-crystal panel.

The 10^{th} aspect of the present invention is the liquid-crystal panel driving device according to the 1^{st} aspect of the present invention, wherein
the reset voltage applied in the power-on state of the liquid-crystal panel is a video signal voltage is for displaying Black display on the liquid-crystal panel.

The 11^{th} aspect of the present invention is the liquid-crystal panel driving device according to the 2^{nd} aspect of the present invention, wherein
the reset voltage selected in the first period is a video signal voltage is for displaying Black display on the liquid-crystal panel.

The 12^{th} aspect of the present invention is the liquid-crystal panel driving device according to the 1^{st} aspect of the present invention, wherein the voltage output means comprises;
a first selection switch to which the video signal voltage and the reset voltage are input and either of them is output,
a second selection switch to which the positive transfer voltage and the negative transfer voltage are input and either of them is output, and
a third selection switch to which outputs of the first selection switch and the second selection switch are input and either of them is output.

The 13^{th} aspect of the present invention is a liquid-crystal display device comprising:
the liquid-crystal panel driving device of any one of the 1^{st} or the 3^{rd} aspect of the present invention;
a liquid-crystal panel having a liquid-crystal layer using OCB-mode liquid crystal; and
a driver of receiving the voltage from the liquid-crystal panel drive and making the liquid-crystal panel perform display.

### ADVANTAGES OF THE INVENTION

According to the above present invention, it is possible to provide a liquid-crystal-panel driving circuit capable of preventing irregularity of a display screen after a power supply is turned off and quickly eliminate disorder of the screen when the power supply is turned on.

Moreover, according to the present invention, it is possible to downsize a liquid-crystal display by realizing the sequence for power on/off by a simple circuit configuration.

### BEST MODE FOR CARRYING OUT THE INVENTION

Embodiments of the present invention are described below by referring to the accompanying drawings.

### Embodiment 1

FIG. 1 shows a block diagram of a driving circuit of embodiment 1 of the present invention. As shown in FIG. 1, the driving circuit 100 is provided with an output terminal 101 of outputting data to a counter electrode 411c of a liquid-crystal display panel, an output system 102 having three selection switches capable of selectively supplying four types of voltages to the output terminal 101, and control means 103 of controlling the selection switches depending on an operation of a liquid-crystal display. Each selection switch is constituted of a selection switch 102a of selectively inputting a voltage V+ or voltage V− serving as an alternating voltage as a transfer voltage from a not-illustrated power supply, a selection switch 102b of selectively inputting a reset voltage Vsc or video-display voltage Vcom, and a selection switch 102c of selectively inputting outputs from the selection switches 102a and 104b and opening and closing of the switches are controlled by control voltages Vc1, Vc2, and Vc3. In this case, the relation between potentials of the voltages is set so that the voltage V− is set to a potential lower than Vcom, the reset voltage Vsc is set to a potential higher than Vcom, and the voltage V+ is set to a potential higher than Vsc on the basis of the voltage Vcom used when a video signal is in a displayed state. For example, the voltage Vcom is set to 5 V, the voltage V+ is set to 30 V, the voltage V− is se to −20 V, and the reset voltage Vsc is set to 7 V.

Moreover, FIG. 2 shows a configuration of a liquid-crystal display device using OCB-mode liquid crystal on which the driving circuit 100 of this embodiment is mounted. In FIG. 2, the driving circuit 100 is built in the source/gate control means 440 and operates depending on a power-on signal or power-off signal of the liquid-crystal panel 410 input from the outside. In FIG. 2, a portion same as or corresponding to that in FIG. 7 is provided with the same symbol and its detailed description is omitted.

Operations of the driving circuit of this embodiment having the above configuration are described below by referring to FIGS. 3 and 4.

First, operations when the power supply of a liquid-crystal display is turned off are described by referring to the timing chart in FIG. 3. Before a control input of power off is applied to the liquid-crystal display and a power-off signal is inputted to the source/gate driving means 440, various voltages of displaying an image on the liquid-crystal panel 410 are applied to respective pixels from the source driver 420 as a normal display period. In this case, because a voltage to be applied to the liquid-crystal layer 411d depends on display video image to be displayed in a liquid-crystal layer region, the arrangement of liquid crystal is ununiform in a bend alignment state.

Then, when a power-off signal is input to the source/gate driving means 440, the control means 103 performs the control of changing the selection switches 102a and 104c to LOW state from a state in which the voltage Vcom is applied and therefore the liquid-crystal panel 410 displays in normal display, and thereby, outputs the voltage V+ to the counter electrode 411c only for a predetermined period. Moreover, a voltage of AVDD/2 is simultaneously applied to the respective pixel electrodes 411b through the source driver 420. The AVDD/2 is set to, for example, 5 V. Moreover, at the same time, the control means 103 also performs the control of turning off the backlight 450. Furthermore, the control means 103 performs the control of changing the selection switch 102a to HIGH state and outputs the voltage V− to the counter electrode 411c for a predetermined period. Thereby, in the case of each pixel of the liquid-crystal panel 410, by applying a transfer voltage serving as an alternating voltage of an absolute value |V₊−AVDD/2| or |V₋−AVDD/2|, which is higher than the voltage applied to liquid-crystal layer during normal driving, the arrangement of liquid crystal in the liquid-crystal layer 411d more quickly transfers to the uniform bend alignment. The applying period of the transfer voltage corresponds to the third period of the second present invention or the fourth period of the third present invention and is set to 150 ms in this case. It is preferable that the applying period is 100 msec or more and it is possible to change the period by monitoring a circumferential environmental temperature and corresponding to the temperature. For example, it is possible to lengthen the period under low-temperature environment or shorten the period under high-temperature environment.

Then, the control means 103 performs control so as to apply the voltage Vcom to the counter electrode 411c. In this case, voltages Vs (black) such as +10 V and 0 V of substantially performing uniform black display are supplied to each pixel electrode 411b through the source driver 420. Thereby, voltages of 5 V are applied to the liquid-crystal layer for a predetermined period and uniform black display is performed.

It is preferable that in previous operations, the transfer voltage |V₊−AVDD/2| or |V₋−AVDD/2| to be applied to a liquid-crystal layer is 1.5 times or more higher than the voltage |Vcom−Vs (black)| to be applied to a liquid-crystal layer when performing black display or more preferable that the former voltage is 2 times or more higher than the latter voltage and the applying period is 100 msec or more. It is also possible to change the period by monitoring a circumferential environmental temperature and changing the period by corresponding to the temperature. For example, it is possible to lengthen the period under low-temperature environment and shorten the period under a high-temperature environment. Particularly, when use under a low-temperature environment such as 0° C. is considered, it is preferable that the period is 300 nsec or more. The applying period of the black display voltage corresponds to the fourth period of the second present invention or the sixth period of the third present invention.

When the black display period is completed, the selection switch 102b is changed to LOW, the reset voltage Vsc is output to the counter electrode 411c, the voltage Vs (white) of substantially performing uniform white display such as a voltage of +7 V is applied to each pixel electrode 411b through the source driver 420, a voltage of 0 V is substantially applied to the liquid-crystal layer, and thereafter supply of voltage is cut off to complete power off. It is preferable that the applying period is 2,000 msec or more and it is possible to change the period by monitoring a circumferential environmental temperature and corresponding to the temperature. For example, it is possible to lengthen the period under low-temperature environment and shorten the period under high-temperature environment. The applying period of the reset voltage Vsc corresponds to the fourth period of the second present invention or the fifth period of the third present invention.

Thus, in the case of the above off operations, by applying a transfer voltage having a potential sufficiently higher than the normal liquid-crystal driving voltage, the liquid-crystal layer 411d quickly transfers to the uniform bend alignment state. Therefore, it is possible to prevent a portion to be quickly transited to the spry alignment and a portion to be slowly transited to the splay alignment from mixing like a conventional example. Thereafter, it is possible to stabilize flickers by applying a black display voltage to each pixel. By continuously applying a reset voltage, it is possible to transfer the whole liquid-crystal layer 411d after a power supply is turned off from uniform bend alignment to uniform splay alignment, effectively remove irregularity and afterimage, and obtain a stable image quality even if outside light comes in after turning off the backlight 450.

Then, operations of a liquid-crystal display by the driving circuit of this embodiment when the power supply is turned on are described below. As shown by the timing chart in FIG. 4, similarly to a conventional example, a transfer state of eliminating the splay alignment by applying a drastic potential difference is inserted for the whole liquid-crystal layer 411d of the liquid-crystal panel 410 between the normal power-on and the normal display state. That is, immediately after the power supply is turned on, the control means 103 is set to a reset state, the selection switches 102a and 104b are set to LOW state, the selection switch 102c is set to HIGH state, a reset voltage Vsc is supplied to the counter electrode 411c, the voltage Vs (white) of performing substantially uniform white display is supplied from the source driver 420, a voltage of 0 V is substantially applied to the liquid-crystal layer 411d, and a uniform arrangement of the splay alignment is once realized. In this case, when not holding the splay alignment, even if a transfer voltage is applied, the liquid-crystal panel 410 may not be transited to the bend alignment enough much. A period of holding the splay alignment corresponds to the first period of the second or third present inventions.

Then, the selection switch 102c is set to LOW state while once keeping the selection switches 102a and 102b as they are so that the voltage V+ is applied to the counter electrode 411c, and a voltage of AVDD/2V is simultaneously applied to pixel electrodes through all source lines from the source driver 420. The AVDD/2 is set to, for example, 5 V. Then, the selection switch 102a is set to HIGH state and a voltage to be applied to all source lines is collapsed from V+ to V−. Thereby, a transfer voltage of |V₊−AVDD/2| or |V₋−AVDD/2| in absolute value which is an alternating voltage is applied to each liquid-crystal layer of the liquid-crystal panel and the liquid-crystal layer of each pixel 411 is transferred from the uniform splay alignment to bend alignment. It is preferable that the magnitude of the transfer voltage in this case is 1.5 or more higher than the voltage |Vcom−Vs (black)| to be applied to the liquid-crystal layer when performing black display similarly to the case of power off or more preferable that the magnitude is 2 or more higher than the voltage. The period of applying the transfer voltage corresponds to the second period of the second or third present invention.

When the transfer period is completed, the control means 103 controls the selection switches 102b and 104c so that they are set to HIGH, that is, all selection switches are set to HIGH state and applies the voltage Vcom to the counter electrode 411c. Moreover, a predetermined video signal is applied to each source line from the source driver 420 and predetermined display is performed.

Thus, by once applying the transfer voltage to the liquid-crystal layers 411d of the liquid-crystal panel 410 and transiting all liquid-crystal layers 411d to the uniform bend alignment and displaying a video signal, it is possible to quickly eliminate disorder of a screen when the power supply is turned on.

As described above, according to the driving circuit of this embodiment 1, a liquid-crystal display device mounting a liquid-crystal panel using OCB-mode liquid crystal makes it possible to effectively remove an after image appearing on a display screen when a power supply is turned off and the same circuit configuration makes it possible to quickly transit the liquid-crystal panel to the bend alignment when the power supply is turned on.

In the case of the description of the embodiment 1, the reset voltage Vsc is set to an almost intermediate potential between voltages V+ and V− in off state. However, it is also allowed that the reset voltage Vsc is lower than the voltage Vcom and an optional potential between transfer voltages V− and V+. Moreover, though black display is performed in the off-state operation, it is allowed to perform white display in the case of normally black. Furthermore, it is allowed to omit the period of black display.

### Embodiment 2

Then, FIG. 5 shows a time chart of explaining another power-off sequence of the driving device for the liquid-crystal display of an embodiment of the present invention. In FIG. 5, (a) shows operations of the source/gate driving means 440 and backlight 450, (b) shows the display operation of the liquid-crystal panel 410, (c) shows the operation of applying a voltage to the liquid-crystal layers 411d, and (d) shows a change of potentials of electrodes in the pixel 411.

An embodiment of the present invention is more specifically described below by referring to FIG. 5. Because opening/closing control of the selection switches 102a to 103c by the control means 130 of applying the voltage Vcom, reset voltage Vsc, and transfer voltages V+ and V− is the same as the embodiment 1, its description is omitted.

In the case of the video display period 301 shown in FIG. 5, various voltages Vcom of displaying videos on the display screen of the liquid-crystal panel 410 are applied to the liquid-crystal panel 410. That is, because a voltage to be applied to the liquid-crystal layer 411d is different in each region of the liquid-crystal layer depending on a video image to be displayed, the arrangement of the liquid crystal is ununiform.

When a power-off signal is input to the liquid-crystal panel 410 from the outside, the source/gate driving means 440 completes the video display period 301 and at the same time, turns off the backlight 450 and starts off-sequence periods 302, 303, and 304 in order.

First in the off-sequence period 302, the control means 103 applies a transfer voltage to the counter electrode 411c of the liquid-crystal panel 410. Similarly to the case of FIG. 3, the transfer voltage in this case is assumed as a voltage 1.5 times or more higher than the voltage to be black-displayed and is an alternating voltage. In the first half and second half of the off-sequence period 302, voltages V+ and V− having the same magnitude and mutually opposite direction on the basis of a pixel electrode are alternately applied between the pixel electrode 411b and the counter electrode 411c in order. Because the alternating voltage is applied to the liquid-crystal layer of the liquid-crystal panel 410, it is possible to prevent uneven distribution of liquid-crystal ions in addition to the advantage of the above high potential difference. As a result, it is possible to prevent flickers of the liquid-crystal layer 411d and the shift of white display is decreased, and it is possible to further shorten the time until becoming splay.

Similarly to the above mentioned, because the transfer voltage in the off-sequence period 302 is set to a voltage higher than the black display voltage the arrangement of liquid crystal in the liquid-crystal layer 411d quickly becomes the uniform bend alignment. Therefore, it is preferable that the off-sequence period 302 is 100 msec or more when a voltage to be applied is approximately 1.5 times higher than the black display voltage.

When the off-sequence period 302 is completed, the control means 103 starts the off-sequence period 303. When a display screen is normally white, an alternating voltage of displaying black gradation on the entire display screen is applied to the liquid-crystal panel 410 in the off-sequence period 303. It is preferable that the black display voltage is applied in the off-sequence period 303 for 100 msec or more.

Thus, by applying a black-display alternating voltage in the off-sequence period 303 after applying a high voltage in the off-sequence period 302, it is possible to stabilize flickers compared with the case of only the off-sequence period 302 and shorten the time until transiting to the splay alignment.

When the off-sequence period 303 is completed, the off-sequence period 304 is started. When the display screen is normally white, the control means 103 applies a voltage of displaying white gradation on the entire display screen to the liquid-crystal panel 410 in the off-sequence period 304. That is, the potential difference between the counter electrode and the pixel electrode is substantially brought to zero by performing white display. Then, the control means 103 performs control so as to bring at least either of the potential difference between the gate line 413 and the pixel electrode 411b and the potential difference between the common electrode 411e (electrode other than pixel electrode) and the pixel electrode to accelerate the transition to the splay alignment.

In this case, because an applied voltage become 0 V when the arrangement of liquid crystal is a uniform state in the liquid-crystal layer 411d, OCB-mode liquid crystal can uniformly transit from the bend alignment to the splay alignment.

After the off-sequence period 304 is completed, the control means 103 starts a power-off period 305. When the power-off period 305 is started, the control means 103 opens the selection switches 102a to 102c to cut off the power supplied from the outside.

At the point of time when the power-off period 305 is started, electric potentials of the counter electrode 411c, pixel electrode, gate line 413, and common electrode 411e are equal to each other. Therefore, transition to the splay alignment state is started from the point of time. Reference numerals 503 and 504 shown in FIG. 6 denote courses of the transition (reverse transition) to the splay alignment state. That is, at the point of time when the power-off period 305 is started, there is no potential difference between a pixel electrode 1402 and a common electrode 1409. Therefore, reverse transfer 504 occurs from the common electrode-1409 side toward the central portion of the pixel electrode 1402 on the pixel electrode 1402. Moreover, because there is no potential difference between the pixel electrode 1402 and a gate line 1407, the reverse transfer 503 occurs from the gate line-1407 side toward the central portion of the pixel electrode 1402 on the pixel electrode 1402. These reverse transfers 503 and 504 occur when a pillar spacer 505 becomes a starting point. Moreover, as time elapses, the reverse transfers 503 and 504 move toward the central portion of the pixel electrode 402 and thereby, transition to the splay alignment state is more quickly completed.

Furthermore, by inserting the off-sequence period 304 of performing white display by the reset voltage Vsc, a potential difference reaching a transfer potential is not generated even if a difference occurs between potentials in the period from the point of time when the power-off period 305 is started until each potentials reaches the ground level (that is, the region A shown by (d) in FIG. 5). Therefore, it is possible that the OCB-mode liquid crystal can more quickly transit to the splay alignment by adding the off-sequence period 304 compared with cases of only the off-sequence period 302, only the off-sequence period 303, and only the off-sequence periods 302 and 303. It is preferable that the off-sequence period 304 continues for 2 sec or more. In this case, the off-sequence periods 303 and 304 correspond to the fourth period of the present invention as a whole and these black voltage and white voltage correspond to a reset voltage of the present invention. Moreover, the off-sequence period 303 corresponds to the sixth period of the third present invention and the off-sequence period 304 corresponds to the fifth period of the third present invention.

For this embodiment, it is described that an alternating voltage is applied in the off-sequence periods 302 and 303. However, it is also allowed to apply a constant voltage. In this case, the advantage that transit to the splay alignment is accelerated is the same as the above described though the advantage that the flicker characteristic is improved cannot be obtained. In this case, by setting the black display period like the case of the off-sequence period 303, it is possible to effectively generate reverse transfer.

Moreover, for this embodiment, it is allowed that a voltage at which white gradation is substantially displayed on a display screen is applied to the liquid-crystal layer 411d in the off-sequence period 304. Also in this case, an advantage same as the above described can be obtained.

Furthermore, it is allowed that the off-sequence period 303 is omitted, the off-sequence period 302 is started after the video display period 301 is completed, and the power-off period 305 is started after the off-sequence period 304 is performed after the off-sequence period 302 is completed. Also in this case, an advantage same as the above described can be obtained. In this case, the off-sequence period 304 corresponds to the fourth period of the second present invention.

Furthermore, it is described that a voltage to be applied to the liquid-crystal layer 411d is uniform. However, when a transfer voltage is applied, it is allowed that the voltage is ununiform. Also in this case, an advantage same as the above described can be obtained.

Though it is described above that the liquid-crystal layer 411d is normally white, it is also allowed that the layer 411d is normally black. In the off-sequence period 303, it is enough that a voltage at which white is substantially displayed on a display screen is applied. Moreover, in the off-sequence period 302, it is enough that a voltage higher than the voltage at which white is displayed on the display screen and equal to or lower than a voltage to be applied to the liquid-crystal layer 411d is applied as a transfer voltage. Furthermore, in the off-sequence period 304, it is enough that a voltage at which black is substantially displayed on a display screen is applied. In this way, it is possible to obtain an advantage same as the above described even if the liquid-crystal layer 411d id normally black.

Furthermore, it is described above that irradiation by the backlight 450 is turned off at the same time as end of the video display period 301. However, it is also allowed that irradiation by the backlight 450 is turned off after end of the off-sequence period 304. Moreover, it is allowed that irradiation by the backlight 450 is turned off before the off-sequence period 304 is started after the video display period 301 is completed. Also in this case, because the liquid-crystal layer 411d can transit from the uniform bend alignment to the splay alignment, irregularity does not occur on the display screen.

Furthermore, it is allowed that irradiation by the backlight 450 is turned off before the video display period 301 is completed.

In the case of the above embodiment, the driving circuit 100 corresponds to a driving circuit of the present invention and the output system 102 and control means 103 correspond to voltage output means of the present invention. Moreover, the output system 102 corresponds to the first driving circuit of the third present invention and the control means 103 corresponds to a control circuit of the third present invention. Furthermore, means of supplying a common potential to the common electrode 411e corresponds to the second driving circuit of the third present invention.

Furthermore, the liquid-crystal panel 416 corresponds to a liquid-crystal panel of the present invention. Furthermore, the voltages V+ and V− or voltages having absolute values of |V₊−AVDD/2| and |V₋−AVDD/2| correspond to a transfer voltage of the present invention, the voltage Vsc corresponds to a reset voltage of the present invention, the voltage Vcom corresponds to a counter voltage when a predetermined video signal is displayed. Furthermore, the selection switch 102a corresponds to a first selection switch of the present invention, the selection switch 102b corresponds to a second selection switch of the present invention, and the selection switch 102c corresponds to a third selection switch of the present invention. Furthermore, the source driver 420 corresponds to a driver of the present invention.

Furthermore, a liquid-crystal display mounting a driving circuit of the present invention is included in the present invention. The OCB-mode liquid crystal is used as a liquid crystal having a bend alignment and a splay alignment. However, it is allowed to use another liquid crystal as long as the liquid crystal can take these states.

### INDUSTRIAL APPLICABILITY

A drive apparatus of liquid-crystal panel of the present invention has advantages capable of preventing irregularity on a display screen after turning off a power supply by a simple circuit configuration and quickly eliminating disorder of the screen when the power supply is turned on and is useful as a liquid-crystal display.

### BRIEF DESCRIPTION OF THE DRAWINGS

FIG. 1 is a block diagram of a drive apparatus according to embodiment 1 or 2 of the present invention;

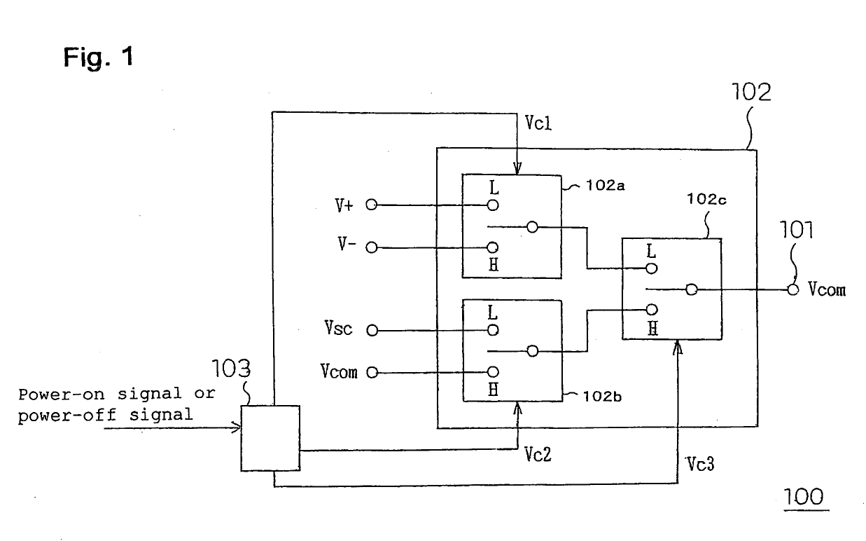

FIG. 2 is a block diagram of a liquid-crystal display device having the drive apparatus according to the embodiment 1 or 2 of the present invention;

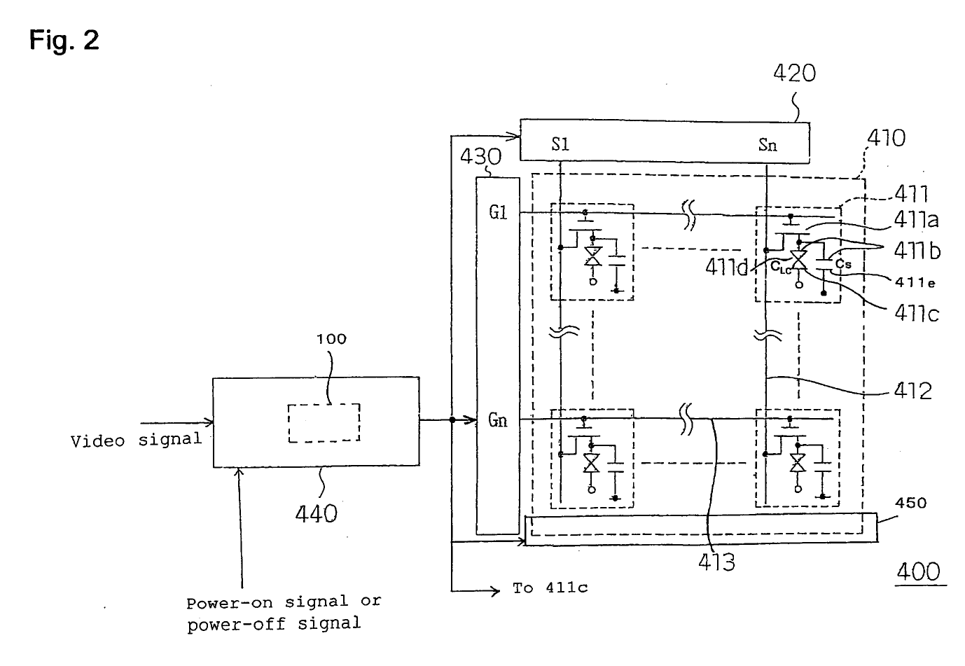

FIG. 3 is an illustration showing a timing chart of explaining a power-off state of the drive apparatus of the embodiment 1 of the present invention;

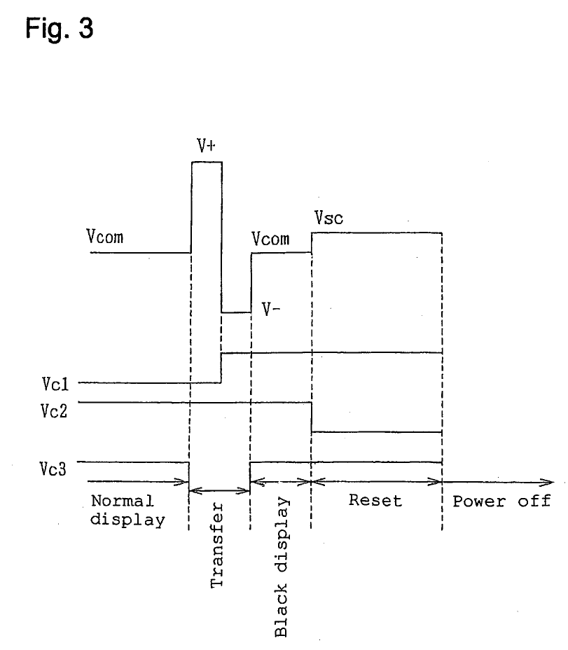

FIG. 4 is an illustration showing a timing chart of explaining a power-on state of the drive apparatus of the embodiment 1 of the present invention;

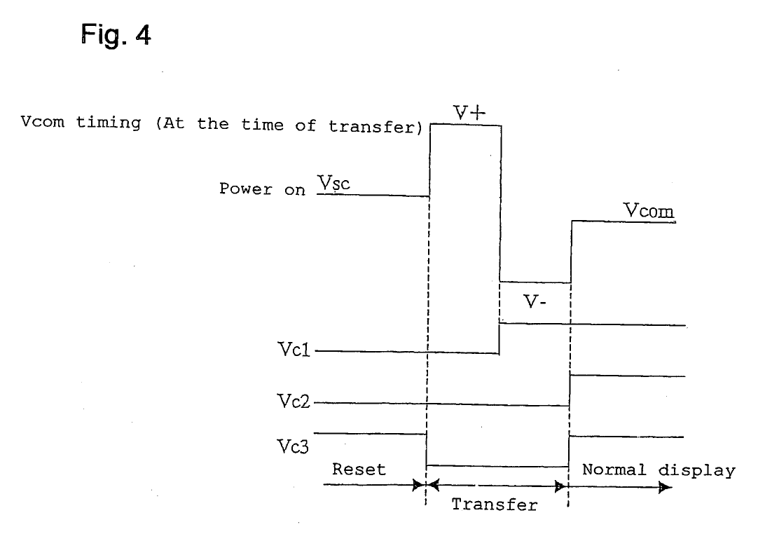

FIG. 5 is an illustration showing a timing chart of explaining a power-off state of the drive apparatus of the embodiment 2 of the present invention;

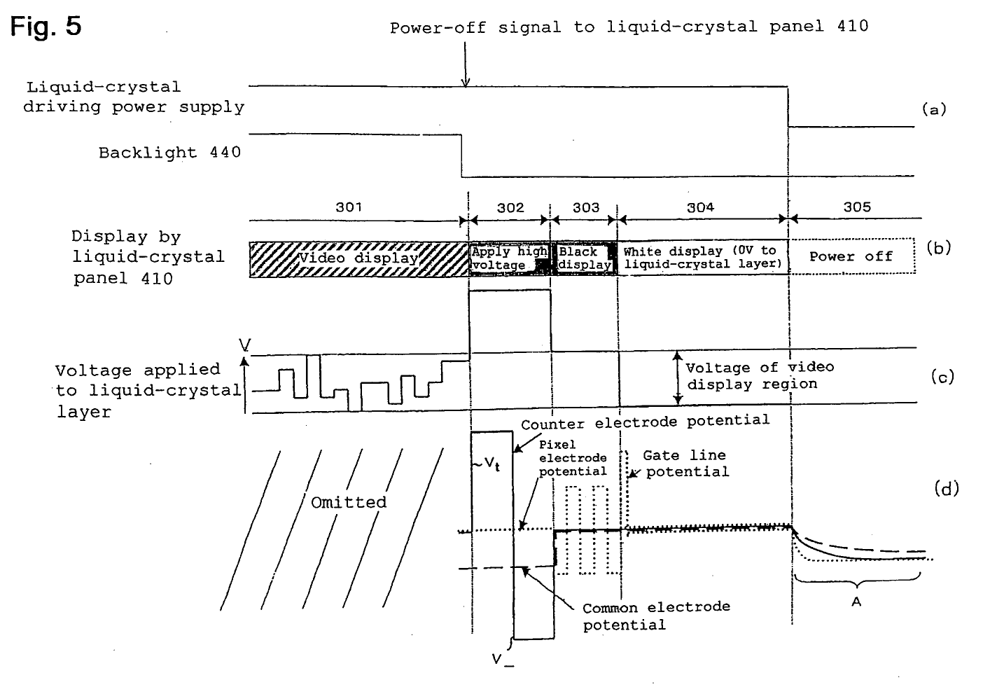

FIG. 6 is an illustration of explaining a state of a liquid-crystal layer in a power-off state of the drive apparatus of the embodiment 2 of the present invention;

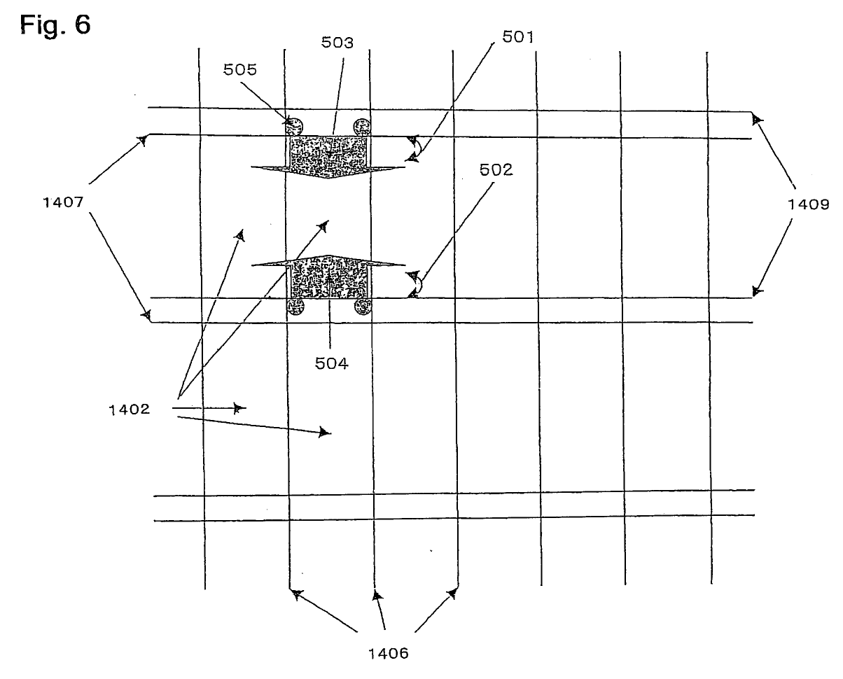

FIG. 7 is an illustration showing a liquid-crystal display device according to a prior art;

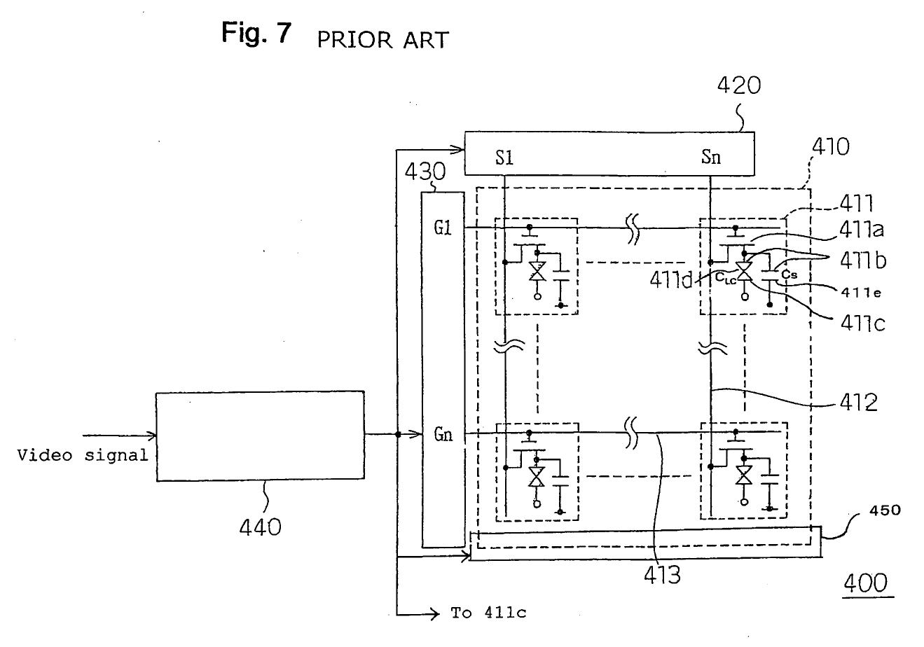

FIG. 8(a) is an illustration of explaining a splay alignment and a bend alignment of the OCB-mode liquid crystal and FIG. 8(b) is an illustration of explaining a splay alignment and a bend alignment of OCB-mode liquid crystal;

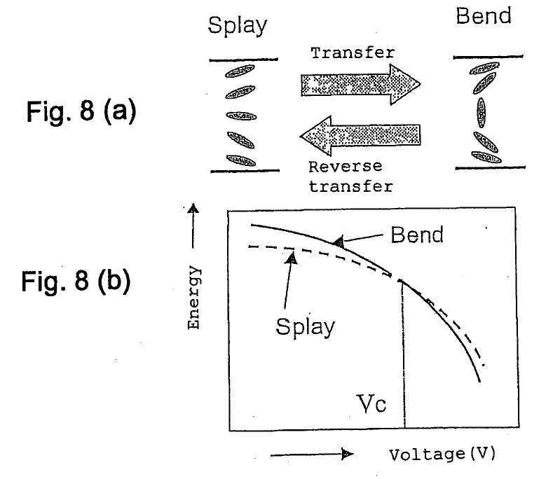

FIG. 9 is an illustration showing a timing chart of explaining the power-off state of a liquid-crystal display device according to a prior art;

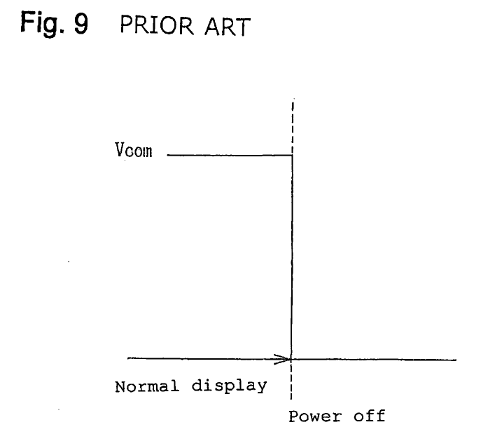

FIG. 10 is an illustration showing a configuration of off-afterimage prevention circuit according to a prior art;

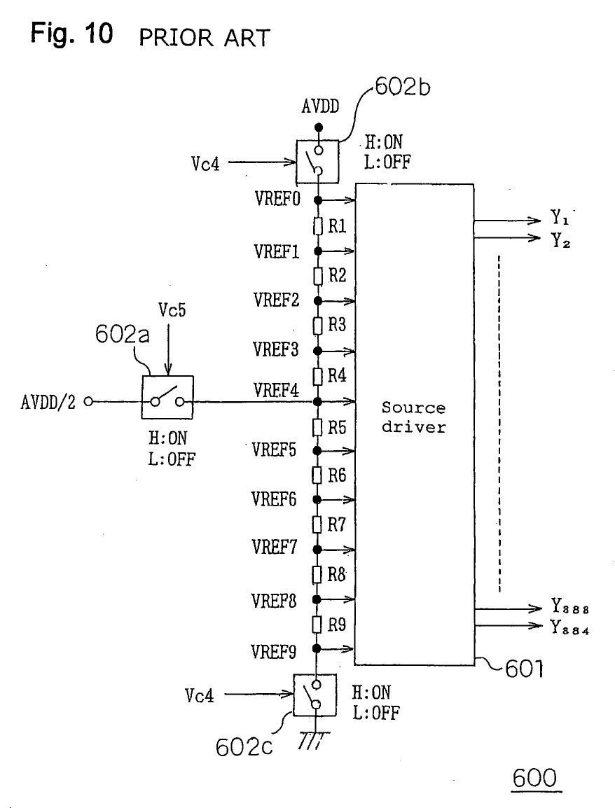

FIG. 11 is an illustration showing a timing chart of explaining operations of off-afterimage prevention circuit according to a prior art;

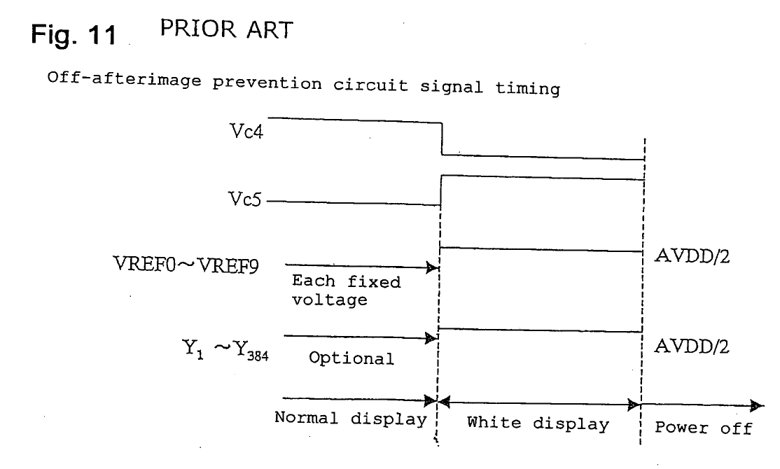

FIG. 12 is an illustration showing a timing chart of explaining the power-on state of a liquid-crystal display device according to a prior art;

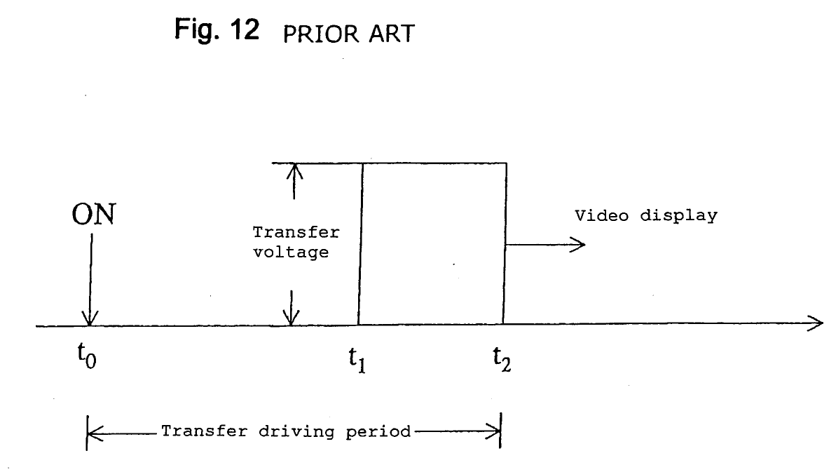

FIG. 13 is an illustration showing a configuration of a transfer circuit according to a prior art; and

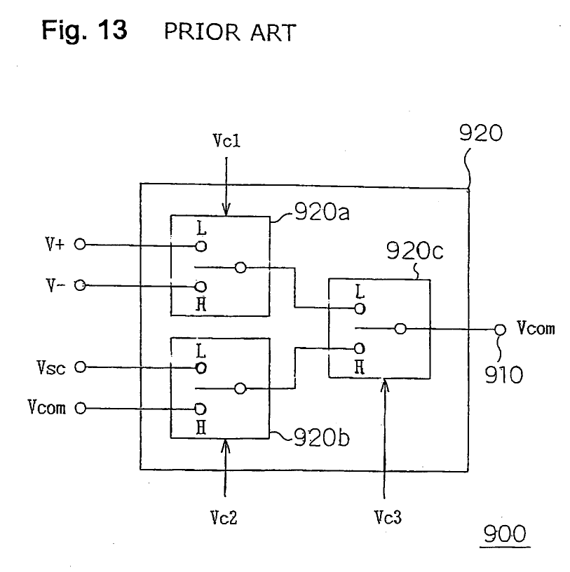

FIG. 14 is an illustration showing a timing chart of explaining operations of a transfer circuit according to a prior art.

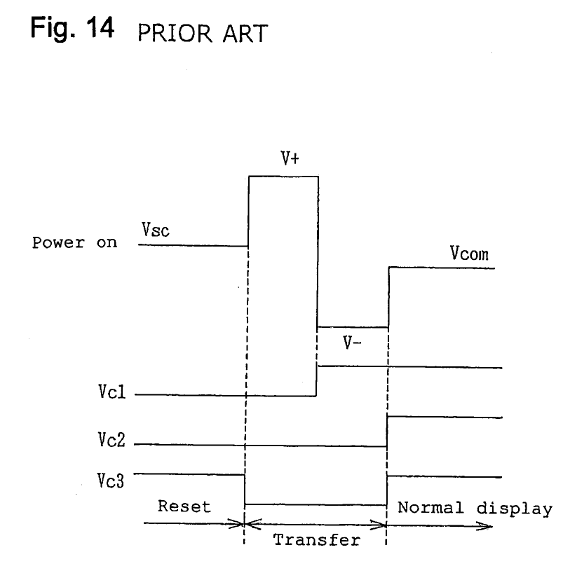

### DESCRIPTION OF SYMBOLS

100 Driving circuit
101 Output terminal
102 Input system
102a, 102b, 102c Selection switch
103 Control means
410 Liquid-crystal panel
411 Pixel
420 source driver
430 Gate driver
440 Source/gate driving means
450 Backlight

What is claimed is:

1. A driving device for applying a voltage to a liquid-crystal panel having a liquid-crystal layer capable of being a splay alignment state or a bent alignment state, comprising:
a voltage output means of outputting at least one voltage selected from voltages including a video signal voltage, a reset voltage, and a transfer voltage for transiting the liquid-crystal panel from the splay alignment to the bend alignment, in accordance with power-off or power-on state of the liquid-crystal display panel, wherein
the voltage output means applies the reset voltage and then transfer voltage to the liquid-crystal display panel in this order before applying the video signal voltage at the power-on state, and applies the transfer voltage and then the reset voltage in this order before stopping to apply voltages at the power-off state.

2. A driving device for applying a voltage to a liquid-crystal panel having a liquid-crystal layer capable of being a splay alignment state or a bent alignment state, comprising:
a voltage output means of selectively outputting one voltage from a plurality of voltages including at least a video signal voltage, a reset voltage, and a transfer voltage for transiting the liquid-crystal panel from the splay alignment state to the bend alignment; wherein
a first period of selecting the reset voltage and a second period of selecting the transfer voltage after the first period are successively set based on an on-signal of the liquid-crystal panel input from the outside, and
a third period of selecting the transfer voltage and a fourth period of selecting the reset voltage after the third period are successively set based on an off-signal of the liquid-crystal panel input from the outside.

3. A driving device for applying a voltage to a liquid-crystal panel having a liquid-crystal capable of being a splay alignment or a bent alignment comprising:
a first driving circuit connected to one-hand electrode of the liquid-crystal panel to selectively apply a transfer voltage of transiting the liquid-crystal panel from the splay alignment to the bend alignment, a video signal voltage, and a reset voltage;
a second driving circuit connected to the other-hand electrode of the liquid-crystal panel to selectively apply a constant potential; and
a control circuit of controlling operations of the first driving circuit and the second driving circuit depending on a power-off signal or power-on signal of the liquid-crystal panel input from the outside; wherein
the control circuit controls the first driving circuit so as to set a first period for selecting the reset voltage, second period for selecting the transfer voltage, and third period for selecting the video signal voltage in this order based on the on-signal, and so as to set a fourth period for selecting the transfer voltage and fifth period for selecting the reset voltage in this order.

4. The liquid-crystal panel driving device according to any one of claims 1 to 3, wherein
the reset voltage has an absolute value smaller than that of the transfer voltage.

5. The liquid-crystal panel driving device according to claim 1, wherein
the voltage output means applies a predetermined video signal voltage to become substantially uniform to each pixel of the liquid-crystal panel between application of the transfer voltage and application of the reset voltage in the power-off state.

6. The liquid-crystal panel driving device according to claim 3, wherein
the control circuit performs the control so as to insert a sixth period for applying a predetermined video signal voltage to become substantially uniform to each pixel of the liquid-crystal panel between the fourth period and the fifth period in the power-off state.

7. The liquid-crystal pane driving device according to claim 5 or 6, wherein
the substantially-uniform predetermined video signal voltage is for displaying Black display on the liquid-crystal panel.

8. The liquid-crystal panel driving device according to claim 7, wherein
the reset voltage applied in the power-off state of the liquid-crystal panel is a video signal voltage is for displaying White display on the liquid-crystal panel.

9. The liquid-crystal panel driving device according to claim 7, wherein
the reset voltage selected in the fifth period is a video signal voltage is for displaying Black display on the liquid-crystal panel.

10. The liquid-crystal panel driving device according to claim 1, wherein
the reset voltage applied in the power-on state of the liquid-crystal panel is a video signal voltage is for displaying Black display on the liquid-crystal panel.

11. The liquid-crystal panel driving device according to claim 2, wherein
the reset voltage selected in the first period is a video signal voltage is for displaying Black display on the liquid-crystal panel.

12. The liquid-crystal panel driving device according to claim 1, wherein the voltage output means comprises;
a first selection switch to which the video signal voltage and the reset voltage are input and either of them is output,
a second selection switch to which the positive transfer voltage and the negative transfer voltage are input and either of them is output, and
a third selection switch to which outputs of the first selection switch and the second selection switch are input and either of them is output.

13. A liquid-crystal display device comprising:
the liquid-crystal panel driving device of any one of claims 1 to 3;
a liquid-crystal panel having a liquid-crystal layer using OCB-mode liquid crystal; and
a driver of receiving the voltage from the liquid-crystal panel drive and making the liquid-crystal panel perform display.
